(19) United States
(12) Patent Application Publication
(10) Pub. No.: US 2014/0042864 A1
(43) Pub. Date: Feb. 13, 2014

(54) DC MOTOR

(71) Applicant: ASMO CO., LTD., Shizuoka-ken (JP)

(72) Inventor: Tetsuaki ICHIKAWA, Iwata-shi (JP)

(73) Assignee: ASMO CO., LTD., Shizuoka-ken (JP)

(21) Appl. No.: 13/962,850

(22) Filed: Aug. 8, 2013

(30) Foreign Application Priority Data
Aug. 13, 2012 (JP) 2012-179399

(51) Int. Cl. H02K 3/28

(52) U.S. Cl. CPC H02K 3/28
USPC 310/206

(57) ABSTRACT

A DC motor has a stator including two magnets arranged in a circumferential direction. An armature includes an armature core having eight slots arranged in a circumferential direction and radially facing the magnets. A commutator rotates integrally with the armature core and includes four segments separated in the circumferential direction by four grooves arranged in the circumferential direction. Coils are wound in a distributed winding in the slots. Two brushes contact the segments. Two coils, which are arranged at an interval of electric angle 180° and connected in series to each other, are connected to two of the segments that are electrically short circuited by each of the brushes so that the two coils extend between the segments. Each groove is located at a position deviated from a position separated by electric angle 180° in the circumferential direction from another one of the grooves.

### BACKGROUND OF THE INVENTION

The present invention relates to a DC motor including a brush for supplying power.

A DC motor includes a stator, an armature, and a brush. The stator includes a plurality of magnetic poles arranged in a circumferential direction. The armature is rotatable and radially faces the stator. The brush supplies power to the armature. The armature, for example, includes an armature core, a commutator, and coils. The armature core includes a plurality of teeth radially extending about the rotation axis of the armature. The commutator, which includes a plurality of segments arranged in the circumferential direction (rotation direction of armature), is rotated integrally with the armature core. The coils are wound as distributed windings around the armature core to extend through slots formed between teeth that are adjacent to each other in the circumferential direction. The brush is in contact with the segments to supply current to the coils through the segments.

Japanese Laid-Open Patent Publication No. 2009-124850, describes an example of such a DC motor in which the number of segments arranged in the commutator may be one-half the number of slots (number of teeth) of the armature core. The DC motor described in Japanese Laid-Open Patent Publication No, 2009-124850 is configured to satisfy the relationship of number of magnetic poles number of slots (number teeth) number of segments=2P:2PN:PN (where P is an integer greater than or equal to two, and N is an odd number that is greater than or equal to three). For example, the DC motor may include four magnetic poles, twenty slots (teeth), and ten segments.

In the commutator of the DC motor in which the number of segments is one-half the number of slots (number of teeth), the number of grooves (undercuts) that separate adjacent segments in the circumferential direction is less than the commutator of a DC motor in which the number of segments is the same or greater than the number of slots. This reduces mechanical wear when the brush traverses the grooves (i.e., when the segment that the brush contacts is switched) so that the duration of the brush is unaffected. Further, this reduces noise that is generated when the brush strikes a segment when the segment that the brush contacts is switched.

### SUMMARY OF THE INVENTION

In the DC motor in which the number of segments is one-half the number of slots, the combination of the number of magnetic poles, the number of slots, and the number of segments does not necessarily have to satisfy the relationship of the number of magnetic poles:number of slots (number of teeth): number of segments=2P:2PN:PN (where P is an integer greater than or equal to two, N is an odd number that is greater than or equal to three), as described in Japanese Laid-Open Patent Publication No. 2009-124850. For example, a DC motor may also satisfy the relationship of the number of magnetic poles:number of slots:number of segments=n:2:nm:mn (where m is a positive integer, and n is an even number that is greater than or equal to two).

However, in such a DC motor, the number of slots and the number of segments are multiples of the number of magnetic poles. Thus, satisfactory rotation may not be obtained due to the current that flows.

It is an object of the present disclosure to provide a rotatable DC motor including n magnetic poles, 2 nm slots, and mn segments.

One aspect of the present disclosure is a DC motor provided with a stator including n (where n is an even number that is greater than or equal to two) magnetic poles arranged in a circumferential direction. An armature includes an armature core that includes 2 nm (where m is a positive integer, and n is an even number that is greater than or equal to two) slots arranged in a circumferential direction and radial facing the magnetic poles. A commutator rotates integrally with the armature core. The commutator includes mn (where m is a positive integer, and n is an even number that is greater than or equal to two) segments separated in the circumferential direction by mn (where m is a positive integer, and n is an even number that is greater than or equal to two) grooves arranged in the circumferential direction. A plurality of coils are wound in a distributed winding in the slots. A plurality of brushes contact the segments. At least two of the coils, which are arranged at an interval that is an integral multiple of electric angle 180° and connected in series to each other, are connected to two of the segments that are electrically short circuited by each of the brushes so that the at least two of the coils extend between the segments. Each of the grooves is located at a position deviated from a position separated by electric angle 180° in the circumferential direction from another one of the grooves.

In the above aspect, each groove is located at a position deviated from a position separated by electric angle 180° in the circumferential direction from another one of the grooves. In other words, a groove is not arranged at a position separated by electric angle 180° in the circumferential direction from another groove. Thus, the nm segments do not have a fixed circumferential dimension. The brushes are often arranged so that an interval of electric angle 180° is provided between an anode brush and a cathode brush. This shifts the commutation timing of the anode brush and the commutation timing of the cathode brush. Thus, the flow of current provided to a coil becomes irregular, and the magnetic balance is disturbed. This generates a rotation force that rotates the armature. As a result, the DC motor including the n magnetic poles, the 2 mn slots, and the mn segments is rotatable.

In a further aspect of the DC motor in the present disclosure, the number of magnetic poles is an even number that is greater than or equal to four, and the segments that are arranged at an interval of electric angle 360° are connected to each other.

in this structure, current may be simultaneously supplied to the connected segments. Accordingly, the number of brushes may be less than n.

In a further aspect of the DC motor in the present disclosure, the coils that are connected in series includes a coil wound as a forward winding and a coil wound as a reverse winding. A circumferential position of each of the brushes is located in the middle of two of the magnetic poles that are adjacent to each other in the circumferential direction.

A further aspect of the DC motor in the present disclosure includes four of the magnetic poles, sixteen of the slots, and eight of the segments.

A further aspect of the DC motor in the present disclosure includes two of the magnetic poles, eight of the slots, and four of the segments.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view of a DC motor of a first embodiment;

FIG. 2 is a schematic view in which the DC motor of the first embodiment is expanded along a plane;

FIG. 3 is a schematic view in which the DC: motor of the first embodiment is expanded along a plane;

FIGS. 4A to 4E are schematic views illustrating a method for setting a circumferential position of a groove in a commutator arranged in the DC motor of the first embodiment;

FIGS. 5A to 5D are schematic views illustrating a supply mode of current in the DC motor of the first embodiment;

FIG. 6 is a cross-sectional view of a DC motor of a second embodiment;

FIG. 7 is a schematic view in which the DC motor of the second embodiment is expanded along a plane;

FIG. 8 is a schematic view in which the DC motor of the second embodiment is expanded along a plane;

FIGS. 9A to 9E are schematic views illustrating a method for setting a circumferential position of a groove in a commutator arranged in the DC motor of the second embodiment; and

FIG. 10 is a schematic view in which a DC motor of another embodiment is expanded along a plane.

### DETAILED DESCRIPTION OF THE INVENTION

### First Embodiment

One embodiment of a DC motor will now be described with reference to the drawings.

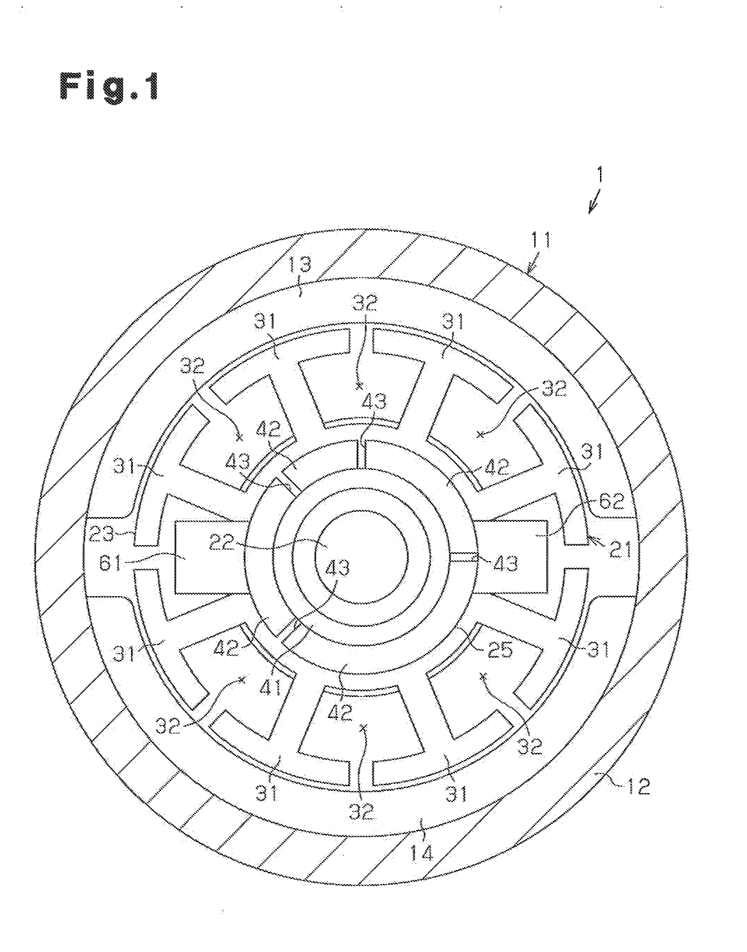

As shown in FIG. 1, a DC motor 1 of the present embodiment includes a substantially cylindrical stator 11 and an armature 21, which radially faces the stator 11. The stator 11 includes a substantially tubular yoke housing 12, and n (where n is an even number that is greater than or equal to two) magnets 13 and 14 arranged in equal angular intervals in the circumferential direction on an inner circumferential surface of the yoke housing 12. In the present embodiment, n is set to “2”. Therefore, one magnet 13 that is an N pole and one magnet 14 that is an S pole are fixed to the inner circumferential surface of the yoke housing 12. The magnets 13 and 14 are arranged in an interval of 180° in the circumferential direction. The DC motor 1 of the present embodiment has two magnetic poles since the stator 11 includes the two magnets 13 and 14.

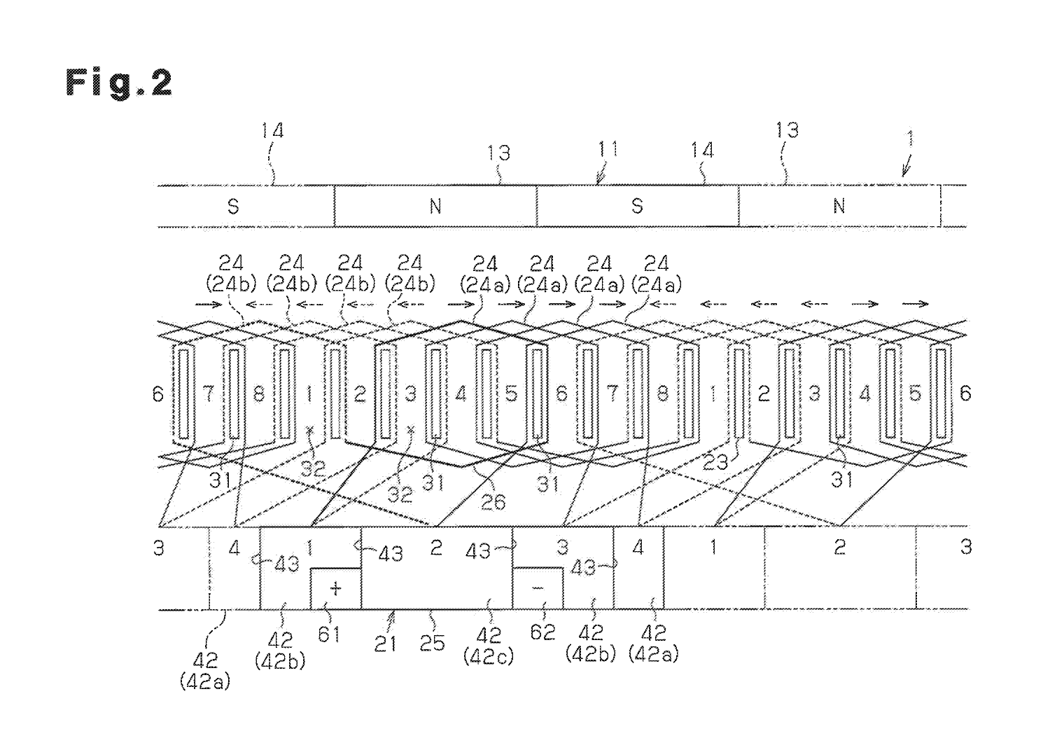

As shown in FIGS. 1 and 2, the armature 21, which is arranged at the radially inner side of the stator 11, includes a rotation shaft 22, an armature core 23 fixed to the rotation shaft 22, coils 24 wound around the armature core 23, and a commutator 25 fixed to the rotation shaft 22. The rotation shaft 22 of the armature 21 is supported to be rotatable relative to the stator 11. FIG. 1 does not show the coils 24.

The armature core 23 radially faces the magnets 13 and 14, and the periphery of the armature core 23 is surrounded by the magnets 13 and 14. The armature core 23 includes 2 nm (where m is a positive integer, and n is an even number that is greater than or equal to two) teeth 31 radially extending about the rotation shaft 22. In the present embodiment, n is set to “2” as described above, and m is set to “2”. Therefore, the armature core 23 of the present embodiment has eight teeth 31. In the armature core 23, a space between the teeth 31 that are adjacent in the circumferential direction forms a slot 32. The armature core 23 includes 2 nm teeth 31, and thereby includes 2 nm (where in is a positive integer, and n is an even number that is greater than or equal to two) slots 32 arranged in the circumferential direction. In the present embodiment, the armature core 23 includes eight teeth 31. The coils 24 are wound in a distributed winding in the eight slots 32 of the armature core 23 by winding conductive wires 26 around the teeth 31.

The commutator 25 includes a cylindrical insulating material 41, and mn (where m is a positive integer, and n is an even number that is greater than or equal to two) segments 42 arranged in the circumferential direction on an outer circumferential surface of the insulating material 41. The commutator 25 is fixed to and rotated integrally with the rotation shaft 22 by press-fitting the rotation shaft 22 into the insulating material 41. Rotation of the rotation shaft 22 rotates the commutator 25 integrally with the armature core 23.

The number of segments 42 arranged in the commutator 25 is mn. This is one-half the number of slots 32 arranged in the armature core 23. In the present embodiment, m is set to “2” and n is set to “2”. Thus, the commutator 25 includes four segments 42, which is one-half of the eight slots 32. A groove 43 (undercut) is arranged between adjacent segments 42 in the circumferential direction. The groove 43 separates adjacent segments 42 in the circumferential direction. The commutator 25 including four segments 42 is provided with four grooves 43 arranged in the circumferential direction. Each groove 43 is located at a position deviated from a position separated by electric angle 180° in the circumferential direction from another groove 43. In the DC motor 1, the number of magnetic poles is “2”. Thus, electric angle 180° corresponds to mechanical angle 180°.

A method for setting the circumferential position of the grooves 43 in the DC motor 1 of the present embodiment including two magnetic poles, eight slots 32, and four segments 42 will now be described.

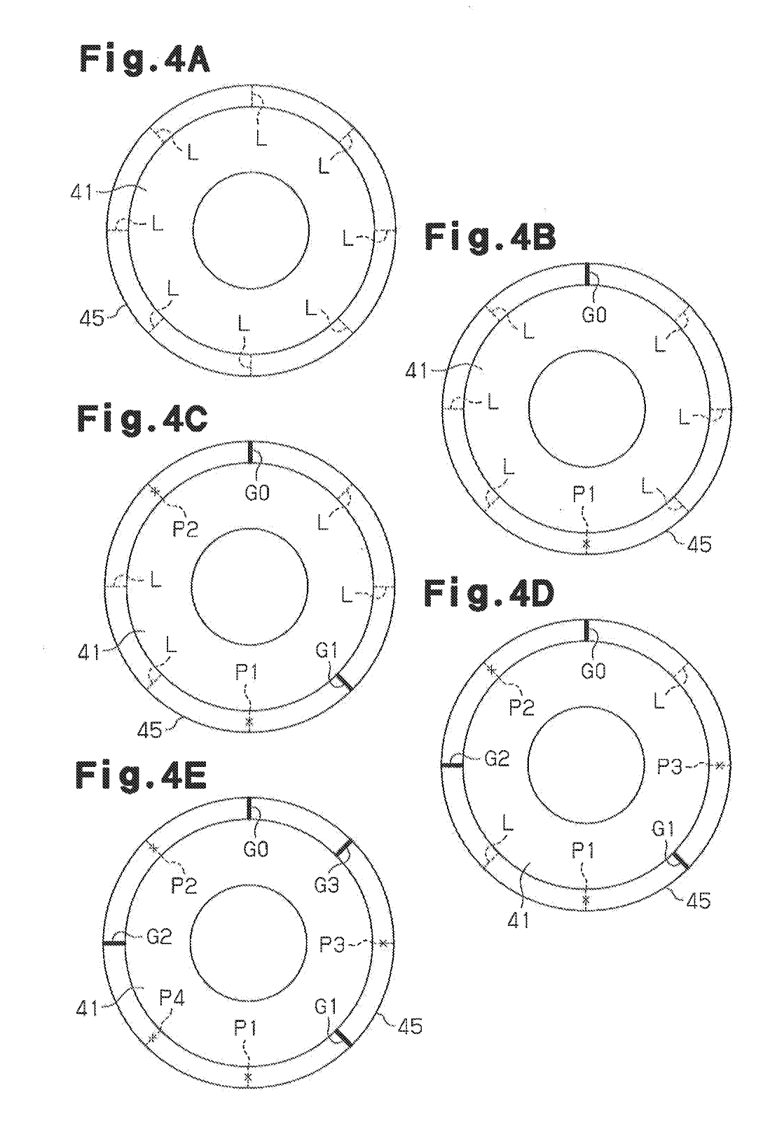

First, as shown in FIG. 4A, a cylindrical segment material 45 is hypothetically divided into eight equal portions, which is the same number as the number of slots 32. The segment material 45 is a member divided into the four segments 42, arranged on the outer circumferential surface of the insulating material 41, and formed from a conductive metal plate material, for example, from a copper plate. In FIG. 4, broken lines show hypothetical dividing lines L for hypothetically dividing the segment material 45. Eight hypothetical dividing lines L for hypothetically dividing the segment material 45 into eight portions are arranged at equal angular intervals in the circumferential direction. The hypothetical dividing lines L extend straight in the radial direction of the segment materials 45.

As shown in FIG. 4B, a reference groove setting position G0, which is used as a reference, is set on one of the eight hypothetical dividing lines L for hypothetically dividing the segment material 45. The reference groove setting position G0 is a position where a groove 43 is formed, and the position where the groove 43 is formed is shown with a thick solid line in FIG. 4.

Then, the hypothetical dividing line L located at a position advanced by electric angle 180° toward one side (counterclockwise direction in FIG. 4B) in the circumferential direction from the reference groove setting position G0 is defined as a first groove non-setting position P1 where a groove 43 is not set (not formed). In FIG. 4, a cross is marked at each position where a groove 43 is not set.

As shown in FIG. 4C, the hypothetical dividing line L adjacent to one side (counterclockwise direction in FIG. 4C) in the circumferential direction from the first groove non-setting position P1 is then defined as a first groove setting position G1 where a groove 43 is set (formed). Then, the hypothetical dividing line L located at a position advanced by electric angle 180° toward one side (counterclockwise direction in FIG. 4C) in the circumferential direction from the first groove setting position G1 is defined as a second groove non-setting position where a groove 43 is not set.

Next, as shown in FIG. 4D, the hypothetical dividing line L adjacent to one side (counterclockwise direction in FIG. 4D) in the circumferential direction from the second groove non-setting position P2 is defined as a second groove setting position G2 where a groove 43 is set. Then, the hypothetical dividing line L located at a position advanced by electric angle 180° toward one side (counterclockwise direction in FIG. 4D) in the circumferential direction from the second groove setting position G2 is defined as a third groove non-setting position P3 where a groove 43 is not set.

Then, as shown in FIG. 4E, the hypothetical dividing line L adjacent to one side (counterclockwise direction in FIG. 4E) in the circumferential direction from the third groove non-setting position P3 is defined as a third groove setting position G3 where a groove 43 is set, Then, the hypothetical dividing line L located at a position advanced by electric angle 180° toward one side (counterclockwise direction in FIG. 4E) in the circumferential direction from the third groove setting position G3 is defined as a fourth groove non-setting position P4 where a groove 43 is not set.

As described above, the groove setting positions G0 to G3 where the grooves 43 are set or the groove non-setting positions P1 to P4 where the grooves 43 are not set are assigned to all the hypothetical dividing lines L. The grooves 43 are formed at the reference groove setting position G0 and the first to third groove setting positions G1 to G3 when the commutator 25 is manufactured. Four grooves 43 that divide the segment material 45 in the circumferential direction are thereby formed on the outer circumferential surface of the commutator 25. As a result, four segments 42 are formed and arranged in the circumferential direction, as shown in FIGS. 1 and 2. The positions of the grooves 43 are set so that a groove 43 is not present at a position separated by electric angle 180° from each groove 43. That is, each groove 43 is arranged at a position deviated from a position separated by electric angle 180° from another groove 43. This forms multiple types of segments 42 having different circumferential dimensions. In other words, the mn (four in the present embodiment) segments 42 separated by the grooves 43 are formed so that the segments 42 have unequal circumferential dimensions. In the present embodiment, the four segments 42 include three types of segments (i.e., first segment 42a, second segment 42b, and third segment 42c) having different circumferential dimensions. The first segment 42a has the smallest circumferential dimension, which is equal to the circumferential dimension of one of the eight portions of the segment material 45 divided in the circumferential direction (i.e., circumferential interval between two adjacent hypothetical dividing lines L in the circumferential direction). The third segment 42c has the largest circumferential dimension, which is three times greater than the circumferential dimension of the first segment 42a. The second segment 42b has an intermediate dimension, which is between the smallest and largest dimensions and which is two times greater than the circumferential dimension of the first segment 42a. The commutator 25 includes two second segments 42b. In the commutator 25, a first segment 42a, a second segment 42b, a third segment 42e, and a second segment 42b are sequentially arranged in the circumferential direction from the first segment 42a.

As shown in FIG. 1, one anode brush 61 and one cathode brush 62 are arranged on the outer circumference of the commutator 25 in the yoke housing 12. The brushes 61 and 62 are forced against the outer circumferential surface of the commutator 25 to contact the outer circumferential surface of the commutator 25. The anode brush 61 and the cathode brush 62 are arranged in two locations separated by electric angle 180° (mechanical angle 180° in the present embodiment) in the circumferential direction. Further, the anode brush 61 and the cathode brush 62 are located between the magnets 13 and 14 in the circumferential direction (between the middle of the N pole magnet 13 in the circumferential direction and the middle of the S pole magnet 14 in the circumferential direction).

The winding mode of the coil 24 will now be described in detail.

As shown in FIG. 2, two coils 24, which are connected in series, are connected to two segments 42 (i.e., two segments 42 adjacent in the circumferential direction) that are electrically short circuited with the anode brush 61 (or cathode brush 62) so as to extend between the two segments 42. The two coils 24 connected in series between the two segments 42 electrically short circuited with the brush 61 (or brush 62) are a first coil 24a and a second coil 24b, which are separated by electric angle 180° in the circumferential direction. The first coil 24a and the second coil 24b, which are connected in series, are wound around four teeth 31 such that the winding direction becomes opposite to each other. In the present embodiment, the first coil 24a is wound as a forward winding, and the second coil 24b is wound as a reverse winding. In FIG. 2, the first coil 24a is shown by a solid line, and the second coil 24b is shown by a broken line.

In FIG. 2, segment numbers “1” to “4” are given to the four segments 42 sequentially in the circumferential direction. Further, slot numbers “1” to “8” are sequentially given in the circumferential direction from the slot 32 of which circumferential position conforms to the segment 42 corresponding to segment number “1”. The winding mode of the coil 24 will be described using the two coils 24 (first coil 24a and second coil 24b) connected to the segments 42 so as to extend from the segment 42 corresponding to segment number “1” to the segment 42 corresponding to segment number “2” adjacent in the circumferential direction by way of example. In FIG. 2, the two coils 24 connected in series between the segments 42 corresponding to segment numbers “1” and “2” are shown with a thick line to facilitate visual understanding. The conductive wire 26 connected (hooking and fusing) to the riser of the segment 42 corresponding to segment number “1” enters the slot 32 corresponding to slot number “2” and wound in a distributed winding to the four teeth 31 between the slot 32 corresponding to slot number “2” and the slot 32 corresponding to slot number “6” to form the first coil 24a. Then, the conductive wire 26 exits the slot 32 corresponding to slot number “6”, enters the slot 32 corresponding to slot number “2”, and is wound in a distributed winding in the direction opposite to the first coil 24a to form the second coil 24b. The second coil 24b is wound around the four teeth 31 located between the slot 32 corresponding to slot number “2” and the slot 32 corresponding to slot number “6”. These four teeth 31 are located opposite in the circumferential direction from the four teeth 31 around which the first coil 24a has just been wound. Then, the conductive wire 26 exits the slot 32 corresponding to slot number “6” and is connected (hooking and fusing) to the riser of the segment 42 corresponding to segment number “2”. Thus, the two coils 24 (i.e., one first coil 24a and one second coil 24b), which are arranged at an interval of electric angle 180° and connected in series to each other, are connected to the segment 42 corresponding to segment number “1” and the segment 42 corresponding to segment number “2” adjacent in the circumferential direction so as to extend between the segments 42. The winding directions of the first coil 24a and the second coil 24h, which are connected in series, are opposite to each other.

In the same manner as the two coils 24 connected to the segments 42 so as to extend between the segments 42 corresponding to segment numbers “1” and “2”, two coils 24 (first coil 24a and second coil 24b) connected in series are also connected to the segments 42 corresponding to segment numbers “2” and “3”, the segments 42 corresponding to segment numbers “3” and “4”, and the segments 42 corresponding to segment numbers “4” and “1” so as to extend between the two corresponding segments 42. In the DC motor 1 of the present embodiment, the number of windings of each coil 24 are all set to the same number.

The operation of the DC motor 1 of the present embodiment will now be described.

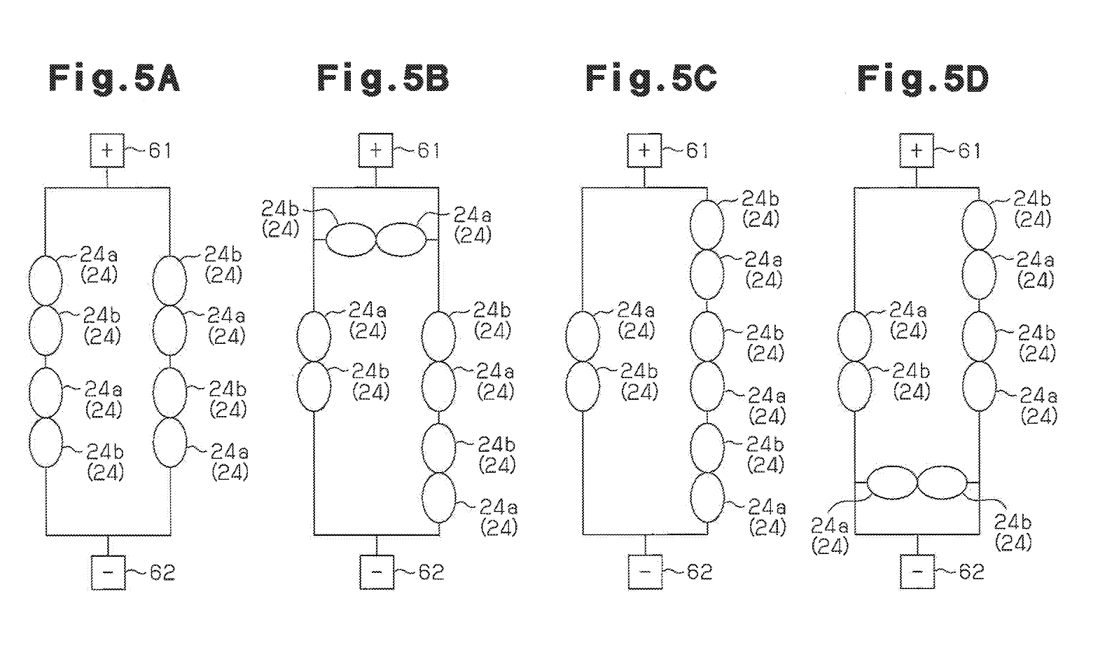

In the state shown in FIG. 2, the anode brush 61 contacts the segment 42 corresponding to segment number “1” and the cathode brush 62 contacts the segment 42 corresponding to segment number “3”. In this state, current is supplied to all eight coils 24 arranged in series between the segment 42 corresponding to segment number “1” and the segment 42 corresponding to segment number “3”, as shown in FIGS. 2 and 5A. Current is supplied in the same direction (see solid line arrow in FIG. 2) to all of the first coils 24a, and current is supplied in the same direction (see broken line arrow in FIG. 2) to all of the second coils 24b.

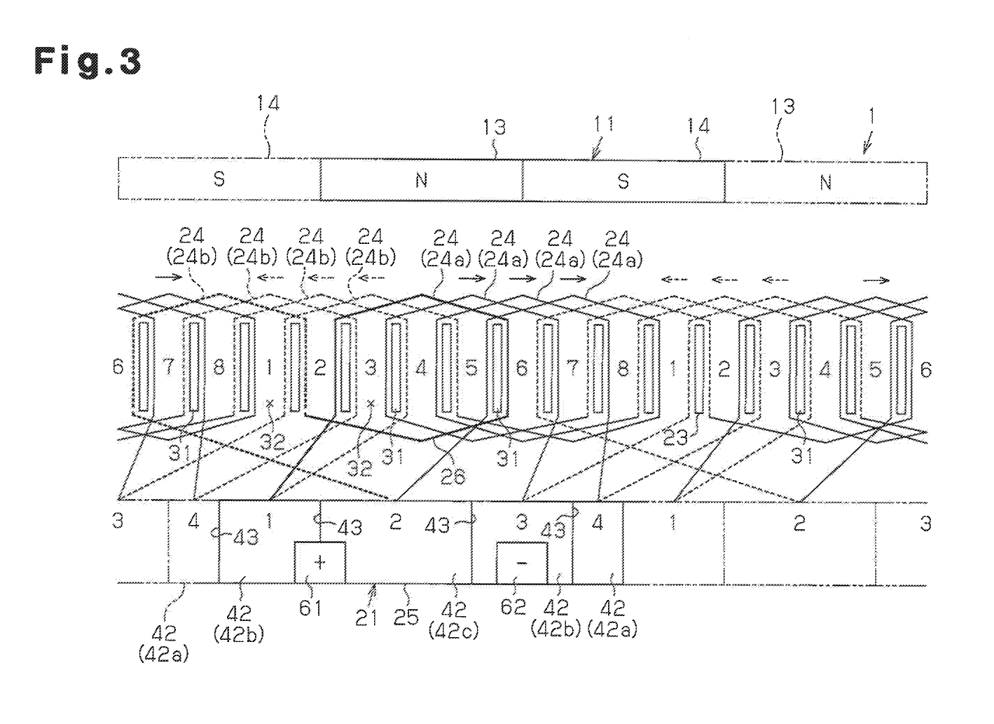

A state in which the armature 21 is rotated by electric angle 22.5° (mechanical angle 22.5°) from the state shown in FIG. 2 is shown in FIG. 3. In the state shown in FIG. 3, the anode brush 61 contacts the segment 42 corresponding to segment number “1” and the segment 42 corresponding to segment number “2” adjacent in the circumferential direction via the groove 43 thus short circuiting the two segments 42. The cathode brush 62 contacts the segment 42 corresponding to segment number “3”. Thus, as shown in FIGS. 3 and 5B, the two coils 24 arranged in series between the segment 42 corresponding to segment number “1” and the segment 42 corresponding to segment number “2” undergo commutation. The first coil 24a in commutation radially faces the circumferentially middle position of the N pole magnet 13 (circumferentially middle position of the magnetic pole), and the second coil 24b in commutation similarly radially faces the circumferentially middle position of the S pole magnet 14 (circumferentially middle position of the magnetic pole). Current is supplied from the brushes 61 and 62 to the four coils 24 arranged in series between the segment 42 corresponding to segment number “1” and the segment 42 corresponding to segment number “3”, and the two coils 24 arranged in series between the segment 42 corresponding to segment number “2” and the segment 42 corresponding to segment number “3”. In this case, current is supplied in the same direction (see solid line arrow in FIG. 3) to the three first coils 24a, and current is supplied in the same direction (see broken line arrow in FIG. 3) to the three second coils 24b. A rotation force for rotating the armature 21 is generated when commutation is performed by only the anode brush 61 shown in FIG. 3.

Then, the armature 21 is further rotated by electric angle 22.5° (mechanical angle 22.5°) from the state shown in FIG. 3. As a result, the anode brush 61 contacts the segment 42 corresponding to segment number “2” and the cathode brush 62 contacts the segment 42 corresponding to segment number “3”. In this state, current is supplied to all eight coils 24 arranged in series between the segment 42 corresponding to segment number “2” and the segment 42 corresponding to segment number “3”, as shown in FIGS. 3 and 5C. Current is supplied in the same direction to all of the first coils 24a, and current is supplied in the same direction to all of the second coils 24b.

When the armature 21 is further rotated, the anode brush 61 contacts the segment 42 corresponding to segment number “2” and the cathode brush 62 contacts the segment 42 corresponding to segment number “3” and the segment 42 corresponding to segment number “4” adjacent in the circumferential direction via the groove 43 thus short circuiting such two segments 42. In this state, the two coils 24 arranged in series between the segment 42 corresponding to segment number “3” and the segment 42 corresponding to segment number “4” are in commutation, as shown in FIGS. 3 and 5D. The first coil 24a in commutation radially faces the circumferentially middle position of the N pole magnet 13 (circumferentially middle position of the magnetic pole), and the second coil 24b in commutation similarly radially faces the circumferentially middle position of the S pole magnet 14 (circumferentially middle position of the magnetic pole). Current is supplied from the brushes 61 and 62 to the two coils 24 arranged in series between the segment 42 corresponding to segment number “2” and the segment 42 corresponding to segment number “3”, and the four coils 24 arranged in series between the segment 42 corresponding to segment number “2” and the segment 42 corresponding to segment number “4”. Current is supplied in the same direction to the three first coils 24a, to which current is supplied, and current is supplied in the same direction to the three second coils 24b, to which current is supplied. The rotation force for rotating the armature 21 is generated in the state the commutation is performed by only the cathode brush 62.

In the present embodiment, the anode brush 61 and the cathode brush 62 are arranged at an interval of electric angle 180°, and the commutator 25 does not include the groove 43 at a position separated by electric angle 180° in the circumferential direction from each groove 43. Therefore, as described above, the timing at which the commutation is performed in the anode brush 61 and the timing at which the commutation is performed in the cathode brush 62 are shifted. Since the commutator 25 does not include the groove 43 at the position of electric angle 180° in the circumferential direction from each groove 43, the circumferential dimensions of the four segments 42 are not fixed. Thus, the distance in which each brush 61 and 62 contacts each segment 42 in the rotation direction of the armature 21 is not equal. Therefore, the supply of current becomes irregular and the magnetic balance is disturbed in the armature 21. The rotation force for rotating the armature 21 is generated and the armature 21 is rotated when the commutation is performed by only the anode brush 61 or with only the cathode brush 62.

The two coils 24 connected in series between the two segments 42 electrically short circuited with the brush 61 (or brush 62) include both the first coil 24a, which is wound as a forward winding, and the second coil 24h, which is wound as a reverse winding. Further, the circumferential positions of the brushes 61 and 62 are in the middle of the two magnets 13 and 14 (between magnetic poles) adjacent in the circumferential direction. Thus, the first coil 24a of a forward winding and the second coil 24b of a reverse winding, which are connected in series, are arranged at the interval of electric angle 180°. When the first coil 24a of a forward winding and the second coil 24b of a reverse winding, which are connected in series, are commutated by the brush 61 (or brush 62), the brush 61 (or brush 62) is arranged at a central portion in the circumferential direction of the first coil 24a and the second coil 24b.

As described above, the first embodiment has the advantages described below.

(1) Each groove 43 is located at a position deviated from a position separated by electric angle 180° in the circumferential direction from another groove 43. Thus, the circumferential dimensions of the four segments are not fixed. The two brushes 61 and 62 are arranged so that the anode brush 61 and the cathode brush 62 are separated by an interval of electric angle 180°. This shifts the timing at which the anode brush 61 performs commutation and the timing at which the cathode brush 62 performs commutation. Therefore, the flow of current supplied to the coil 24 becomes irregular, and the magnetic balance is disturbed thus generating the rotation force for rotating the armature 21, and rotating the armature 21. As a result, the DC motor 1 including two magnetic poles, eight slots, and four segments becomes rotatable.

(2) Two coils 24 (first coil 24a and second coil 24h) separated by electric angle 180° are connected in series. Thus, the number of segments 42 becomes one-half the number of slots 32. Therefore, the number of grooves 43 is less than when the number of segments is the same as or greater than the number of slots. Mechanical wear that occurs when the brush 61 and 62 traverses the groove 43 (i.e., when the segment 42 to contact is switched) is thus reduced. As a result, the duration of the brushes 61 and 62 is unaffected. Further, noise generated when the brushes 61 and 62 strike a segment 42 when switching segments 42 is suppressed. The number of grooves 43 formed in the segment material 45 also becomes small when the commutator 25 is manufactured. Thus, the manufacturing of the commutator 25 is facilitated.

(3) The two coils 24 (i.e., first coil 24a and the second coil 24b) connected in series between the two segments electrically short circuited by the brush 61 (or brush 62) are arranged at an interval of electric angle 180° (mechanical angle 180° in the present embodiment). The interval between the two coils 24 connected in series is equal to the interval in the circumferential direction of the N pole magnet 13 and the S pole magnet 14. Therefore, when current is supplied to the coil 24 via the segment 42, the rotation force for rotating the armature 21 is generated in a balanced manner.

(4) The two coils 24 connected in series between the two segments 42 electrically short circuited by the brush 61 (or brush 62) include both the first coil 24a, which is wound as a forward winding, and the second coil 24b, which is wound as a reverse winding. Further, the circumferential positions of the brushes 61 and 62 are located between the two magnets 13 and 14 (between the magnetic poles) adjacent in the circumferential direction. Therefore, the first coil 24a of a forward winding and the second coil 24b of a reverse winding, which are connected in series, are arranged at an interval of electric angle 180°. The brush 61 (or brush 62) for commutating the first coil 24a of a forward winding and the second coil 24b of a reverse winding, which are connected in series, is arranged between the first coil 24a and the second coil 24b when commutating the first coil 24a and the second coil 24b. Therefore, the winding mode of the coil 24 (i.e., first coil 24a and second coil 24b) is simplified.

### Second Embodiment

One embodiment of the DC motor will be described below with reference to the drawings. The same reference numerals are denoted on the configurations same as the first embodiment, and the description thereof will be omitted.

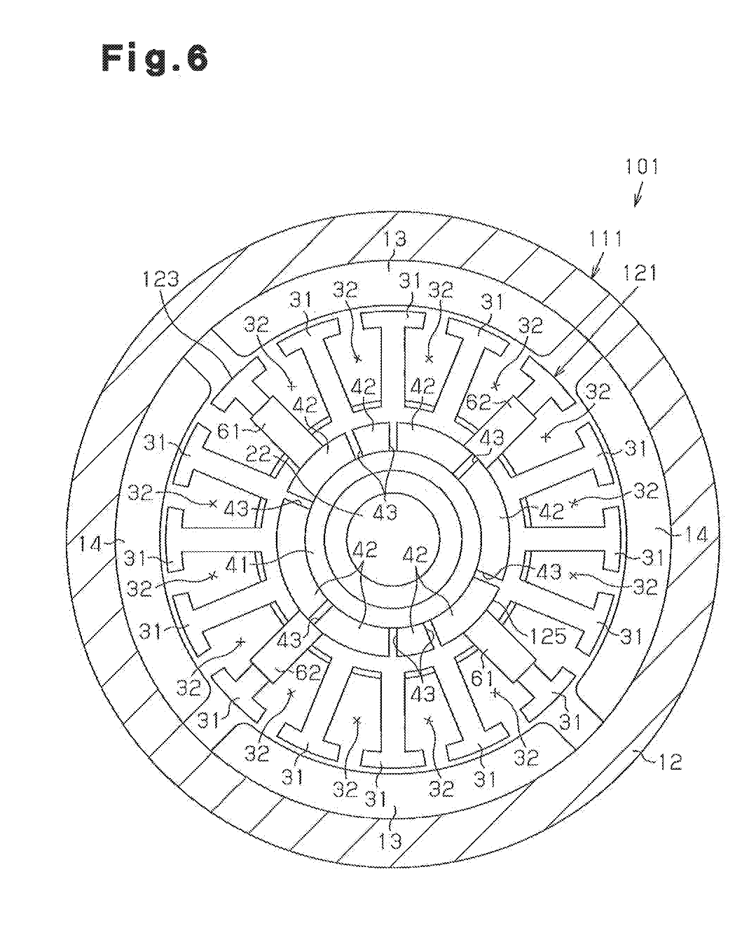

As shown in FIG. 6, a DC motor 101 of a second embodiment includes a substantially cylindrical stator 111, and an armature 121 that radially faces the stator 111. The stator 111 includes the yoke housing 12, and n (where n is an even number that is greater than or equal to two) magnets 13 and 14 arranged in equal angular intervals in the circumferential direction on the inner circumferential surface of the yoke housing 12. In the present embodiment, n is set to “4”. Therefore, two N pole magnets 13 and two S pole magnets 14 are fixed to the inner circumferential surface of the yoke housing 12. The magnets 13 and 14 are arranged at an interval of 90° in the circumferential direction so that the N pole and the S pole are alternately arranged in the circumferential direction. The DC motor 101 of the present embodiment has four magnetic poles since the stator 111 includes four magnets 13 and 14.

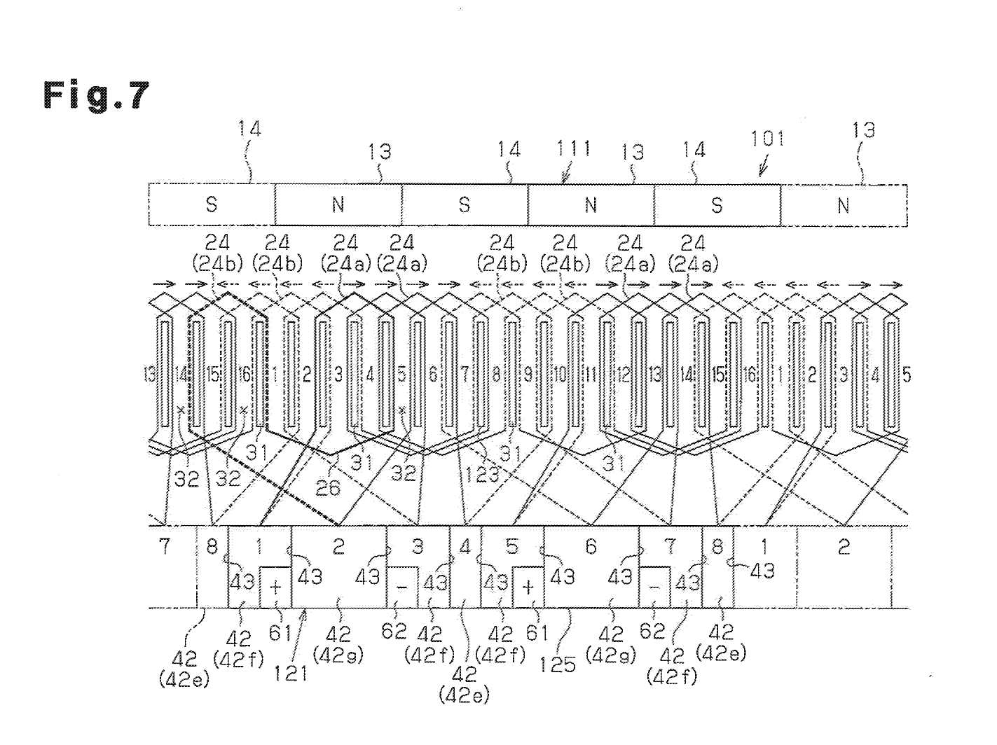

As shown in FIGS. 6 and 7, the armature 121 is arranged at the radially inner side of the stator 111, and includes the rotation shaft 22, an armature core 123 fixed to the rotation shaft 22, a coil 24 wound around the armature core 123, and a commutator 125 fixed to the rotation shaft 22. The rotation shaft 22 of the armature 121 is supported to be rotatable relative to the stator 111. FIG. 6 does not show the coil 24.

The armature core 123 radially faces the magnets 13 and 14, and the periphery of the armature core 123 is surrounded by the magnets 13 and 14. The armature core 123 includes 2 nm (where m is a positive integer, and n is an even number that is greater than or equal to two) teeth 31 radially extending about the rotation shaft 22. In the present embodiment, n is set to “4” as described above, and in is set to “2”. Therefore, the armature core 123 of the present embodiment has sixteen teeth 31. The armature core 123 includes 2 nm teeth 31, and thus includes 2 nm (where m is a positive integer, and n is an even number that is greater than or equal to two) (16 in the present embodiment) slots 32 arranged in the circumferential direction. The coil 24 is wound in a distributed winding on the sixteen slots 32 of the armature core 123 by winding the conductive wire 26 around the teeth 31.

In the commutator 125, the number of segments 42 arranged in the circumferential direction on the outer circumferential surface of the insulating material 41 is mn (where in is a positive integer, and n is an even number that is greater than or equal to two), which is one-half the number of slots 32 arranged in the armature core 123. In the present embodiment, m is set to “2” and n is set to “4”. Thus, the commutator 125 includes eight segments 42, which is one-half of the sixteen slots 32. The segments 42 adjacent in the circumferential direction are separated in the circumferential direction by the groove (undercut) 43 arranged in between. The commutator 125 provided with the eight segments 42 includes eight grooves 43 arranged in the circumferential direction. Each groove 43 is located at a position deviated from the position separated by electric angle 180° in the circumferential direction from another groove 43. In the DC motor 101, the number of magnetic poles is “4”. Thus, electric angle 180° is a mechanical angle 90° C.

A method for setting the circumferential position of the groove 43 in the DC motor 101 of the present embodiment including four magnetic poles, sixteen slots 32, and eight segments 42 will now be described.

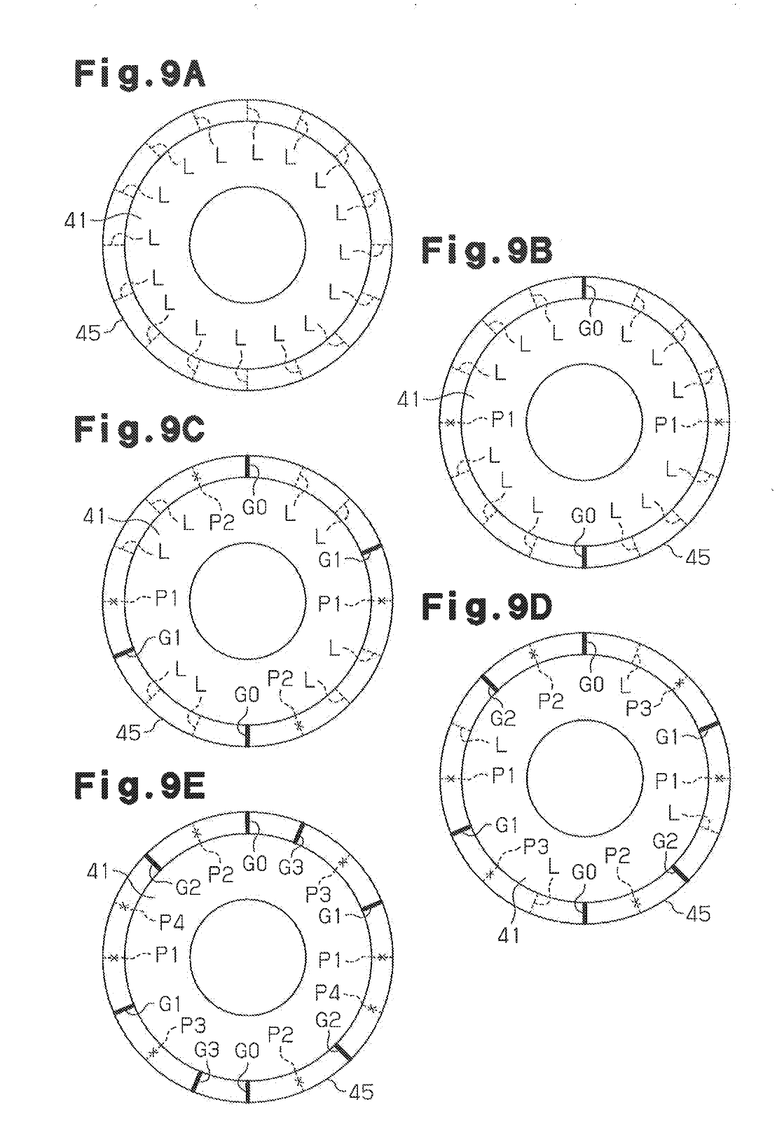

First, as shown in FIG. 9A, the segment material 45 is hypothetically divided into sixteen portions, which is the same number as the number of slots 32. In FIG. 9, the hypothetical dividing line L for hypothetically dividing the segment material 45 is shown with a broken line. Sixteen hypothetical dividing lines L for hypothetically dividing the segment material 45 into sixteen portions are arranged at equal angular intervals in the circumferential direction, and extended straight in the radial direction of the segment material 45.

As shown in FIG. 9B, the reference groove setting position G0 is set on the hypothetical dividing line L. In the present embodiment, the stator 111 includes four magnets 13 and 14 (four magnetic poles). Thus, electric angle 360° corresponds to the mechanical angle 180°. Therefore, two electric angles 360° exist in the mechanical angle 360°. The reference groove setting position G0 is used as a reference and set at two of the sixteen hypothetical dividing lines L separated by electric angle 360°. In FIG. 9, the position where a groove 43 is formed is shown by a solid thick line.

Then, each hypothetical dividing line L located at a position advanced by electric angle 180° toward one side (counterclockwise direction in FIG. 9B) in the circumferential direction from the reference groove setting position G0 is defined as a first groove non-setting position P1 where a groove 43 is not set (not formed). In FIG. 9, a cross is marked at each position where a groove 43 is not set.

Next, as shown in FIG. 9C, each hypothetical dividing line L adjacent on one side (counterclockwise direction in FIG. 9C) in the circumferential direction from each first groove non-setting position P1 is defined as the first groove setting position G1 where a groove 43 is set (formed). Then, each hypothetical dividing line L located at a position advanced by electric angle 180° toward one side (counterclockwise direction in FIG. 9C) in the circumferential direction from each first groove setting position G1 is defined as a second groove non-setting position P2 where a groove 43 is not set.

Then, as shown in FIG. 9D, each hypothetical dividing line L adjacent on one side (counterclockwise direction in FIG. 9D) in the circumferential direction from each second groove non-setting position P2 is defined as a second groove setting position G2 where a groove 43 is set. Then, each hypothetical dividing line L located at a position advanced by electric angle 180° toward one side (counterclockwise direction in FIG. 9D) in the circumferential direction from each second groove setting position G2 is defined as a third groove non-setting position P3 where a groove 43 is not set.

Then, as shown in FIG. 9E, each hypothetical dividing line L adjacent on one side (counterclockwise direction in FIG. 9E) in the circumferential direction from each third groove non-setting position P3 is defined as a third groove setting position G3 where a groove 43 is set. Then, the hypothetical dividing line L located at a position advanced by electric angle 180° toward one side (counterclockwise direction in FIG. 9E) in the circumferential direction from each third groove setting position G3 is defined as a fourth groove non-setting position P4 where a groove 43 is not set.

As described above, the groove setting positions G0 to G3 where grooves 43 are set or the groove non-setting positions P1 to P4 where grooves 43 are not set are assigned to all the hypothetical dividing lines L. The grooves 43 are formed at the reference groove setting position G0 and the first to third groove setting positions G1 to G3 when the commutator 25 is manufactured. Eight grooves 43 that divide the segment material 45 in the circumferential direction are thereby formed on the outer circumferential surface of the commutator 125, and as a result, eight segments 42 arranged in the circumferential direction are formed, as shown in FIGS. 6 and 7. The positions of the grooves 43 are set so that a groove 43 is not present at a position separated by electric angle 180° from each groove 43. That is, each groove 43 is arranged at a position deviated from a position separated by electric angle 180° from another groove 43. This forms multiple types of segments 42 having different circumferential dimensions. In other words, the mn (four in the present embodiment) segments 42 separated by the grooves 43 are formed so that the segments 42 have unequal circumferential dimensions. In the present embodiment, the eight segments 42 include three types of segments (i.e., first segment 42e, second segment 42f, and third segment 42g) having different circumferential dimensions. The first segment 42e has the smallest circumferential dimension, which is equal to the circumferential dimension of one of the sixteen portions of the segment material 45 divided in the circumferential direction (i.e., circumferential interval between two adjacent hypothetical dividing lines L in the circumferential direction). The commutator 125 includes two first segments 42e. The third segment 42c has the largest circumferential dimension, which is three times greater than the circumferential dimension of the first segment 42e. The commutator 125 includes two third segments 42c. The second segment 42f has an intermediate dimension, which is between the smallest and largest dimensions and which is two times greater than the circumferential dimension of the first segment 42e. The commutator 125 includes four second segments 42b. In the commutator 125, a first segment 42e, a second segment 42f, a third segment 42g, and a second segment 42f are sequentially arranged in the circumferential direction from the first segment 42e.

As shown in FIG. 6, two anode brushes 61 and two cathode brushes 62 are arranged on the outer circumference of the commutator 125 in the yoke housing 12. Each brush 61 and 62 is forced against the outer circumferential surface of the commutator 125 to contact the outer circumferential surface of the commutator 125. The anode brush 61 and the cathode brush 62 are alternately arranged in the circumferential direction, and the anode brush 61 and the cathode brush 62 adjacent in the circumferential direction are arranged at an interval of electric angle 180° (mechanical angle 90° in the present embodiment). Further, the brushes 61 of the same polarity are arranged at an interval of electric angle 360° (mechanical angle 180° in the present embodiment), and the brushes 62 of the same polarity are arranged at an interval of electric angle 360° (mechanical angle 180° in the present embodiment). Each of the brushes 61 and 62 is located at a circumferentially middle position between the magnets 13 and 14 adjacent in the circumferential direction (circumferentially middle position between the circumferentially middle position of the N pole magnet 13 and the circumferentially middle position of the S pole magnet 14 in the magnets 13 and 14 adjacent in the circumferential direction).

The winding mode of the coil 24 will now be described in detail.

As shown in FIG. 7, two coils 24, which are connected in series, are connected to the two segments 42 (i.e., two segments 42 adjacent in the circumferential direction) electrically short circuited with the anode brush 61 (or cathode brush 62) so as to extend between the two segments 42. The two coils 24 connected in series between the two segments 42 electrically short circuited with the brush 61 (or brush 62) are the first coil 24a and the second coil 24b, which are separated by electric angle 180° in the circumferential direction. The first coil 24a and the second coil 24b, which are connected in series, are respectively wound around three teeth 31 in opposite winding directions. In the present embodiment, the first coil 24a is wound as a forward winding, and the second coil 24b is wound as a reverse winding. In FIG. 7, the first coil 24a is shown with a solid line, and the second coil 24b is shown with a broken line.

In FIG. 7, segment numbers “1” to “8” are given to the eight segments 42 in order in the circumferential direction. Further, slot numbers “1” to “16” are given in order in the circumferential direction from the slot 32 in the vicinity of the segment 42 corresponding to segment number “1”. The winding mode of the coil 24 will now be described using the two coils 24 (first coil 24a and second coil 24b) connected to the segments 42 so as to extend from the segment 42 corresponding to segment number “1” to the segment 42 corresponding to segment number “2” adjacent in the circumferential direction by way of example. In FIG. 7, the two coils 24 connected in series between the segments 42 corresponding to segment numbers “1” and “2” are shown with a thick line to facilitate visual understanding. The conductive wire 26 connected (hooking and fusing) to the riser of the segment 42 corresponding to segment number “1” enters the slot 32 corresponding to slot number “2” and is wound in a distributed winding to the three teeth 31 between the slot 32 corresponding to slot number “2” and the slot 32 corresponding to slot number “5” to form the first coil 24a. Then, the conductive wire 26 exits the slot 32 corresponding to slot number “5”, enters the slot 32 corresponding to slot number “1”, and is wound in a distributed winding in the direction opposite to the first coil 24a around the three teeth 31 between the slot 32 corresponding to slot number “14” and the slot 32 corresponding to slot number “1” to form the second coil 24b. Then, the conductive wire 26 exits the slot 32 corresponding to slot number “14” and connected (hooking and fusing) to the riser of the segment 42 corresponding to segment number “2”. Thus, the two coils 24 (i.e., one first coil 24a and one second coil 24b), arranged at an interval of electric angle 180° and connected in series to each other, are connected to the segment 42 corresponding to segment number “1” and the segment 42 corresponding to segment number “2” adjacent in the circumferential direction so as to extend between the segments 42. The winding directions of the first coil 24a and the second coil 24b, which are connected in series, are opposite to each other.

In the same manner as the two coils 24 connected to and extended between the segments 42 corresponding to segment numbers “1” and “2”, two coils 24 (first coil 24a and second coil 24h), which are connected in series, are also connected to and extended between the segments 42 corresponding to segment numbers “2” and “3” the segments 42 corresponding to segment numbers “3” and “4”, the segments 42 corresponding to segment numbers “4” and “5”, the segments 42 corresponding to segment numbers “5” and “6”, the segments 42 corresponding to segment numbers “6” and “7”, the segments 42 corresponding to segment numbers “7” and “8”, and the segments 42 corresponding to segment numbers “8” and “1”. In the DC motor 101 of the present embodiment, the number of windings of each coil 24 are all set to the same number.

The operation of the DC motor 101 of the present embodiment will now be described.

In the state shown in FIG. 7, the anode brush 61 contacts the two segments 42 corresponding to segment numbers “1” and “5”, and the cathode brush 62 contacts the two segments 42 corresponding to segment numbers “3” and “7”. In this state, current is supplied to all sixteen coils 24, that is, the four coils 24 arranged in series between the segment 42 corresponding to segment number “1” and the segment 42 corresponding to segment number “3”, the tour coils 24 arranged in series between the segment 42 corresponding to segment number “1” and the segment 42 corresponding to segment number “7”, the four coils 24 arranged in series between the segment 42 corresponding to segment number “5” and the segment 42 corresponding to segment number “3”, and the four coils 24 arranged in series between the segment 42 corresponding to segment number “5” and the segment 42 corresponding to segment number “7”. Current is supplied in the same direction (see solid line arrow in FIG. 7) to all of the first coils 24a, and current is supplied in the same direction (see broken line arrow in FIG. 7) to all of the second coils 24b.

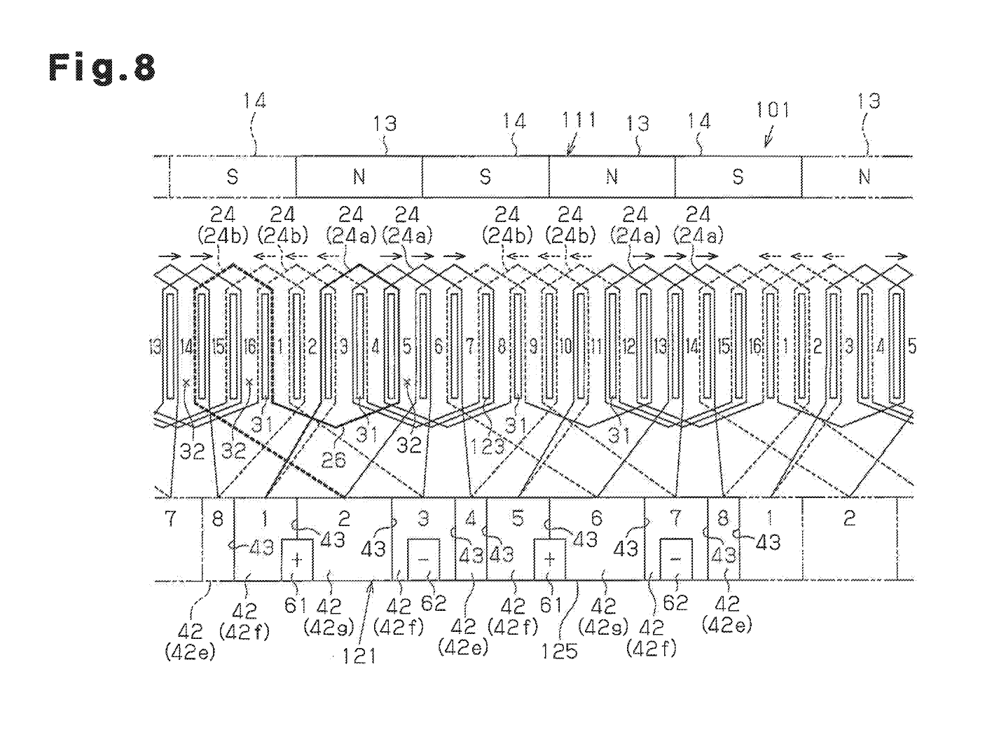

A state in which the armature 121 is rotated by electric angle 22.5° (mechanical angle 11.25°) from the state shown in FIG. 7 is shown in FIG. 8, in the state shown in FIG. 8, the segment 42 corresponding to segment number “1” and the segment 42 corresponding to segment number “2” adjacent in the circumferential direction via the groove 43 are short circuited by one anode brush 61, and the segment 42 corresponding to segment number “5” and the segment 42 corresponding to segment number “6” adjacent in the circumferential direction via the groove 43 are short circuited by the other anode brush 61. The cathode brush 62 contacts the two segments 42 corresponding to segment numbers “3” and “7”. The two coils 24 connected between the segment 42 corresponding to segment number “1” and the segment 42 corresponding to segment number “2”, and the two coils 24 connected between the segment 42 corresponding to segment number “5” and the segment 42 corresponding to segment number “6” are in commutation. The first coil 24a in commutation radially faces the circumferentially middle position of the N pole magnet 13 (circumferentially middle position of the magnetic pole), and the second coil 24b in commutation radially faces the circumferentially middle position of the S pole magnet 14 (circumferentially middle position of the magnetic pole). Current is supplied from the brushes 61 and 62 to the four coils 24 arranged in series between the segments 42 corresponding to segment numbers “1” and “7”, the two coils 24 arranged in series between the segments 42 corresponding to segment numbers “2” and “3”, the four coils 24 arranged in series between the segments 42 corresponding to segment numbers “5” and “3”, and the two coils arranged in series between the segments 42 corresponding to segment numbers “6” and “7”, in this case, current is supplied in the same direction (see solid line arrow in FIG. 8) to the six first coils 24a, to which current is supplied, and current is supplied in the same direction (see broken arrow in FIG. 8) to the six second coils 24h, to which current is supplied. The rotation force for rotating the armature 121 is generated in a state the commutation is performed by only the anode brush 61 shown in FIG. 8.

In the present embodiment, the anode brush 61 and the cathode brush 62 are arranged at an interval of electric angle 180°, and each groove 43 is located at a position deviated from a position separated by electric angle 180° in the circumferential direction from another groove 43. Therefore, as described above, the timing at which the commutation is performed in the anode brush 61 and the timing at which the commutation is performed in the cathode brush 62 are shifted. Further, since each groove 43 is located at a position deviated from the position separated by electric angle 180° in the circumferential direction from another groove 43, the circumferential dimensions of the eight segments 42 are not fixed. Thus, the distance in which each brush 61 and 62 contacts each segment 42 in the rotation direction of the armature 121 is not equal. Therefore, the supply of current becomes irregular and the magnetic balance is disturbed in the armature 121. The rotation force for rotating the armature 121 is generated and the armature 121 is rotated when the commutation is performed by only the anode brush 61 or with only the cathode brush 62.

The two coils 24 connected in series between the two segments 42 electrically short circuited with the brush 61 (or brush 62) include both the first coil 24a, which is wound as a forward winding, and the second coil 24h, which is wound as a reverse winding. Further, the circumferential positions of the brushes 61 and 62 are located between the two magnets 13 and 14 (between magnetic poles) adjacent in the circumferential direction. Thus, the first coil 24a of a forward winding and the second coil 24b of a reverse winding, which are connected in series, are arranged at an interval of electric angle 180°. When the first coil 24a of a forward winding and the second coil 24h of a reverse winding, which are connected in series, are commutated by the brush 61 (or brush 62), the brush 61 (or brush 62) is arranged at a middle position in the circumferential direction between the first coil 24a and the second coil 24b.

The second embodiment has the following advantage in addition to advantages (2) to (4) of the first embodiment.

(5) The circumferential dimensions of the eight segments are not fixed since each groove 43 is located at a position deviated from the position separated by electric angle 180° in the circumferential direction from another groove 43. A total of four brushes 61 and 62 are arranged so that the anode brush 61 and the cathode brush 62 are arranged at the interval of electric angle 180°. Thus, the timing at which the anode brush 61 performs commutation and the timing at which the cathode brush 62 performs commutation are shifted. Therefore, the flow of current supplied to the coil 24 becomes irregular, and the magnetic balance is disturbed. This generates the rotation force for rotating the armature 121 and rotates the armature 121. As a result, the DC motor 101 including four magnetic poles, sixteen slots, and eight segments is rotatable.

Each embodiment of the present invention may be modified as below.

In each embodiment described above, the circumferential position of each brush 61 and 62 is located at a circumferentially middle position between the magnets 13 and 14 adjacent in the circumferential direction (circumferentially middle position between the circumferentially middle position of the N pole magnet 13 and the circumferentially middle position of the S pole magnet 14 in the magnets 13 and 14 adjacent in the circumferential direction). However, each of the brushes 61 and 62 may be arranged so that the circumferential position is located at a circumferentially middle position of the magnet 13 or the magnet 14 (circumferentially middle position of the magnetic pole). In this case, the two coils 24 connected in series between the two segments 42 short circuited with the brush 61 (or brush 62) are wound around the slot 32 so as to be commutated when the circumferentially middle position of each coil 24 radially faces the respective circumferentially middle position of the magnet 13 or the magnet 14.

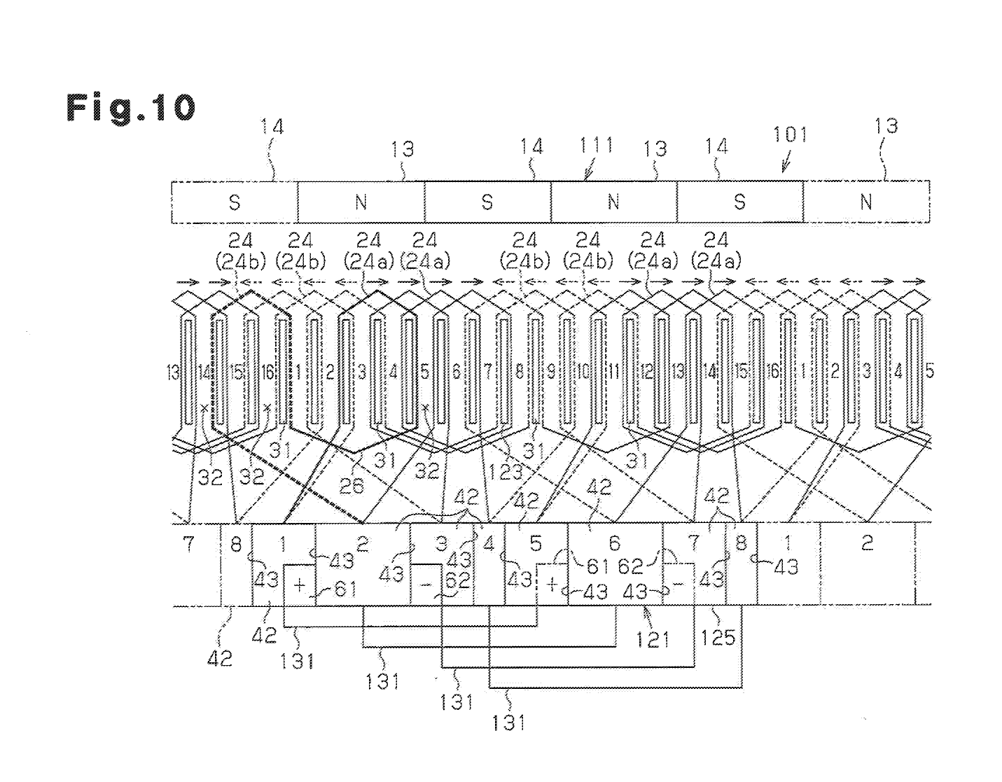

In the DC motor 101 of the second embodiment, the segments 42 arranged at the interval of electric angle 360° may be connected, as shown in FIG. 10. In the example shown in FIG. 10, the segments 42 arranged at the interval of electric angle 360° are short circuited with an equalizer 131. The current thus can be simultaneously supplied to the connected segments 42. Therefore, at least one of the anode brush 61 or the cathode brush 62 shown by a double-dashed line is omitted. In other words, the number of brushes 61 and 62 becomes less than n. If the number of brushes 61 and 62 is less than n, the number of components is reduced compared to when the number of brushes 61 and 62 is n. Therefore, the manufacturing cost of the DC motor 101 is reduced. When the segments 42 arranged at the interval of electric angle 360° are connected, the anode brush 61 and the cathode brush 62 shown by a double-dashed line do not have to be omitted.

In each embodiment described above, the two coils 24 connected in series are connected to the two segments 42 short circuited with the brush 61 (or brush 62) so as to extend between such segments 42. However, a plurality of coils 24 arranged at the interval of an integral multiple of electric angle 180° and connected in series to each other merely need to be connected to the two segments 42 short circuited with the brush 61 (or brush 62) so as to extend between such segments 42. The plurality of coils 24 arranged at an interval of an integral multiple of electric angle 180° and connected in series to each other preferably include both the coil 24 that is wound as a forward winding and the coil 24 that is wound as a reverse winding (winding wound in opposite direction with respect to forward winding). In this case, in the plurality of coils 24 connected in series, the winding mode of the coil 24 is simplified by having the winding directions of the coils 24 arranged at the interval of an odd number multiple of electric angle 180° as opposite directions, and the winding directions of the coils 24 arranged at the interval of an even number multiple of electric angle 180° as the same direction.

The DC motor 1 of the first embodiment includes two magnets 13 and 14 (two magnetic poles), eight slots 32, and four segments 42. The DC motor 101 of the second embodiment includes four magnets 13 and 14 (four magnetic poles), sixteen slots 32, and eight segments 42. However, the number of magnets 13 and 14 (number of magnetic poles), the number of slots 32, and the number of segments 42 are not limited. The DC motor merely needs to include n magnetic poles, 2 nm slots 32, and mn segments 42. Here, m is a positive integer and n is an even number that is greater than or equal to two. In the DC motor including n magnetic poles, 2 nm slots 32, and mn segments 42, at least two coils 24 arranged at an interval of an integral multiple of electric angle 180° and connected in series to each other are connected to the two segments 42 electrically short circuited with each brush 61 and 62. Each groove (undercut) 43 is located at a position deviated from a position separated by electric angle 180° in the circumferential direction. According to such configuration, the DC motor including n magnetic poles, 2 nm slots 32, and mn segments 42 becomes rotatable.

The present examples and embodiments are to be considered as illustrative and not restrictive, and the invention is not to be limited to the details given, herein, but may be modified within the scope and equivalence of the appended claims.

1. A DC motor comprising:
a stator including n (where n is an even number that is greater than or equal to two) magnetic poles arranged in a circumferential direction;
an armature including
an armature core that includes 2 nm (where m is a positive integer, and n is an even number that is greater than or equal to two) slots arranged in a circumferential direction and radial facing the magnetic poles,
a commutator that rotates integrally with the armature core, wherein the commutator includes inn (where m is a positive integer, and n is an even number that is greater than or equal to two) segments separated in the circumferential direction by inn (where m is a positive integer, and n is an even number that is greater than or equal to two) grooves arranged in the circumferential direction, and
a plurality of coils wound in a distributed winding in the slots; and
a plurality of brushes that contact the segments,
wherein at least two of the coils, which are arranged at an interval that is an integral multiple of electric angle 180° and connected in series to each other, are connected to two of the segments that are electrically short circuited by each of the brushes so that the at least two of the coils extend between the segments; and
each of the grooves is located at a position deviated from a position separated by electric angle 180° in the circumferential direction from another one of the grooves.

2. The DC motor according to claim 1, wherein
the number of magnetic poles is an even number that is greater than or equal to four; and
the segments that are arranged at an interval of electric angle 360° are connected to each other.

3. The DC motor according to claim 1, wherein the coils that are connected in series includes a coil wound as a forward winding and a coil wound as a reverse winding, a circumferential position of each of the brushes is located in the middle of two of the magnetic poles that are adjacent to each other in the circumferential direction.

4. The DC motor according to claim 1, comprising four of the magnetic poles, sixteen of the slots, and eight of the segments.

5. The DC motor according to claim 1, comprising two of the magnetic poles, eight of the slots, and four of the segments.
